(19) United States
(12) Patent Application Publication
(10) Pub. No.: US 2010/0212166 A1
(43) Pub. Date: Aug. 26, 2010

(54) Hydro-tension releasing knife blade

(76) Inventor: David A. Visnack, Liberty Lake, WA (US)

Correspondence Address: LUKINS & ANNIS, 717 WEST SPRAGUE AVE., SUITE 1600, SPOKANE, WA, 99201, US

(21) Appl. No.: 12/378,970

(22) Filed: Feb. 23, 2009

(51) Int. Cl. B26B 9/00

(52) U.S. Cl. 30/346

(57) ABSTRACT

A surface friction reducing and hydro-tension releasing knife blade having a cutting edge, a back edge, a first side, an opposing second side and a tip. A plurality of spacedly arrayed protrusions on the first side and on the opposing second side between the cutting edge and back edge provide a plurality of spacedly arrayed inclined ramps from the planar blade side to a crest that separate the item cut from the blade side to reduce surface friction and to relieve hydro-tension.

### RELATED APPLICATIONS

There are no other patent applications related hereto filed in the United States of America or in any other country.

### BACKGROUND OF INVENTION

1. Field of Invention

This invention relates to cutlery, and more particularly to a knife blade that reduces surface friction and hydro-tensive attraction between the blade and adjacent surface of an item being cut.

2. Background and Description of Prior Art

Cutting blades have been known for ages and present cutting blade styles can be traced backward through history to two fundamentally and geographically distinct blade making techniques. One style arose in Europe and culminated with the development of the Broad Sword. The second style arose in the Orient and culminated with the development of the Samurai Sword.

Blades of the European style are characteristically wide from cutting edge to back edge and are made of uniformly hardened steel. European style blades typically have one straight cutting edge and a significantly thickened back edge to provide strength. The thickness of the back edge functions as a wedge that separates the item being cut as the blade passes therethrough. European style blades are typically heavy, and are more adept at chopping than slicing.

Oriental style blades characteristically have a thin blade from cutting edge to back edge, are lightweight and have an arcuate cutting edge from tip to hilt. The cutting edge is hardened steel while the back edge, which is only minimally thickened, is of a softer steel allowing the blade to flex without breaking. Oriental'style blades slice as they pass through an object due to the arcuate cutting edge. Because of the blade's thinness and the minimal thickening of the back edge, Oriental blades do not separate surfaces of a cut item so far apart. For these reasons Oriental style blades are generally considered more efficient than European style blades.

Historically, blades of both styles were created by hammering repeatedly folded billets of steel into a rough blade shape and then sharpening and polishing the cutting edge by grinding. The hammering and grinding necessitated that the blade sides be predominantly planar and smooth.

With the advent of modern manufacturing processes, and the availability of hardened steel, mass production techniques have taken over and knife blades are now more commonly stamped from planar sheets of hardened steel or cast in a rough blade shape. The blades are then sharpened and subjected to a variety of chemical, heat treating and tempering processes to maximize desirable characteristics in the finished knife blade.

Once the blade has been hardened and tempered, sharpening is performed by grinding the blade along one edge on the opposing side surfaces until the cutting, edge has a thickness measured in thousandths of an inch. In order to obtain such a cutting edge, the grinding necessarily occurs over a large surface area on each side of the blade. Final sharpening of high-quality knife blades is generally completed by manually polishing the blades with high-speed rotary buffing machines to remove the burr from the cutting edge.

Both historical and modern knife blade manufacturing techniques have made the sides of the knife blade predominantly planar and smooth. This is a result of the blades being hammered into shape from a repetitively folded billet, or stamped from sheets of hardened steel, and also as a result of the sharpening and polishing processes to form the cutting edge on the blade.

The efficiency of a cutting blade is negatively affected by surface friction between the blade's sides and the item being cut, and by a surface attraction phenomenon which causes cut items to stick to the blade's sides.

The precise cause of this surface attraction phenomenon is unknown but is presumed to be a result of vacuum being formed between the blade's sides and the cut material as the cell walls of the material are disrupted by passage of the knife blade therethrough. It is believed this effect is similar to that of a suction cup sticking to a smooth surface. For purposes of this patent application, this surface attraction phenomenon is hereinafter called “hydro-tension”.

Hydro-tension is a problem faced by all knife users. For professional chefs hydro-tension significantly affects productivity because thinly sliced food stuffs, especially those with higher moisture content, stick to the knife blade's sides making it difficult to quickly and efficiently repetitively cut thin slices of fruits, vegetables, meat, fish and the like, such as sushi. Although professional chefs usually employ advanced culinary knife handling techniques to minimize hydro-tension, it remains a problem that affects productivity and may negatively affect the visual presentation of the food if the plural thin slices are not correctly aligned when the food item is “plated”. For amateur chefs and most other knife users, hydro-tension creates a safety risk because as each cut is made the knife user must “push off” the sliced material from the blade side. This effort takes time and increases risk as the user's fingers are in close proximity to the cutting edge.

To reduce surface friction and reduce hydro-tension modern technologies have made blades thinner, applied lubricating coatings such as Teflon® and drilled holes in the blades. The reasoning has been if the blade causes less material displacement, has highly polished smooth and slick surfaces or has reduced surface area, the efficiency of the blade will increase. However, there are always “trade-offs”. As cutting blades have become thinner they have become more brittle; for instance ceramic blades are very sharp, but also very easy to break. Lubricating coatings, such as Teflon® make blades thicker and difficult to sharpen. Holes make blades weaker, more susceptible to breaking and difficult to clean and sanitize.

Makers of Oriental style blades attempted to reduce surface friction and reduce hydro-tension by grinding plural spaced apart concave depressions (reliefs) in the blade proximate the cutting edge. The reliefs reduced surface area in contact with the item and allowed air between the blade and the “cut” surfaces to reduce hydro-tension. This has worked to some degree, but has not completely resolved the problem.

Despite sophisticated advancements in knife blades that embody modern materials and modern manufacturing processes, the problems of surface friction and hydro-tension remain unresolved. What is needed is a knife blade that is sharp, is hard and yet not brittle, minimizes surface friction and relieves hydro-tension to prevent thinly sliced items from adhering to the sides of the blade as the material is cut.

The instant knife blade differs from prior knife blades by improving the sides of the blade rather than modifying the cutting edge or applying lubricative coatings.

My invention improves a cutting blade's efficiency by forming a plurality of spacedly arrayed protrusions on the sides of the blade. Each protrusion gradually lifts material away from the planar portion of the blade reducing surface friction and relieving hydro-tension. This departs from previously attempted solutions that have provided smooth polished planar surfaces or concave reliefs which provide some lubricity, but create widely dispersed surface friction and vacuum.

The protrusions are preferably convex and circular because this shape provides an even and consistent ramp from the blade side surface to a “crest” of the protrusion. The shape performs consistently regardless of the angle or motion used with the blade.

The formation of a plurality of spacedly arrayed protrusions on the sides of a knife blade was not previously possible for mass production because knife blades were hammered into shape from a repetitively folded billet, or stamped from a planar sheet of hardened steel and thereafter ground and polished into shape. With the advent of Computer Assisted Manufacturing (CAM) machines and other modern manufacturing processes it is now possible to form such a plurality of spacedly arrayed protrusions on the blade sides.

My invention does not reside in any one of the identified features individually but rather in the synergistic combination of all of its structures, which give rise to the functions necessarily flowing therefrom as hereinafter specified and claimed.

### SUMMARY

A surface friction reducing and hydro-tension releasing knife blade having a cutting edge, a back edge, a first side, an opposing second side and a tip. A plurality of spacedly arrayed protrusions on the first side and opposing second side between the cutting edge and back edge provide a plurality of inclined ramps to separate the cut material from the blade sides to reduce surface friction and to relieve hydro-tension.

In providing such an apparatus it is:

a principal object to provide a knife blade having increased efficiency.

a further object to provide a knife blade that reduces surface friction between the blade's sides and adjacent surfaces of the item being cut.

a further object to provide a knife blade that reduces hydro-tension between the blade's sides and adjacent surfaces of the item being cut.

a further object to provide a knife blade that thinly sliced food-stuffs do not adhere to.

a further object to provide a knife blade having a plurality of spacedly arrayed protrusions on the blade sides between the cutting edge and the back edge.

a further object to provide a knife blade that prevents vacuum between the knife blade's sides and adjacent surfaces of the item being cut.

a still further object to provide a surface friction reducing and hydro-tension releasing knife blade that is of new and novel design, of rugged and durable nature, of simple and economic manufacture and one that is otherwise well suited to the uses and purposes for which it is intended.

Other and further objects of my invention will appear from the following specification and accompanying drawings which form a part hereof. In carrying out the objects of my invention it is to be understood that its structures and features are susceptible to change in design and arrangement with only one preferred and practical embodiment of the best known mode being illustrated in the accompanying drawings and specified as is required.

### BRIEF DESCRIPTIONS OF DRAWINGS

In the accompanying drawings which form a part hereof and wherein like numbers refer to similar parts throughout:

FIG. 1 is an isometric side, cutting edge and tip end view of my knife blade having a handle interconnected to the tang.

FIG. 2 is an orthographic right side view of my knife blade.

FIG. 3 is an orthographic left side view of my knife blade.

FIG. 4 is an orthographic top view of my knife blade.

FIG. 5 is an orthographic bottom view of my knife blade.

FIG. 6 is an enlarged orthographic back, forward looking view of my knife blade.

FIG. 7 is an enlarged orthographic front, rearward looking view of my knife blade.

FIG. 8 is an isometric partial cut-away side, cutting edge and tip end view of my knife blade similar to that of FIG. 1, less the handle.

FIG. 9 is an orthographic partial cut-away side view of my knife blade showing diamond shaped protrusions.

FIG. 10 is an orthographic partial cut-away side view of my knife blade showing square protrusions.

FIG. 11 is an orthographic partial cut-away side view of my knife blade showing triangle shaped protrusions.

FIG. 12 is an orthographic partial cut-away side view of my knife blade showing elliptical protrusions.

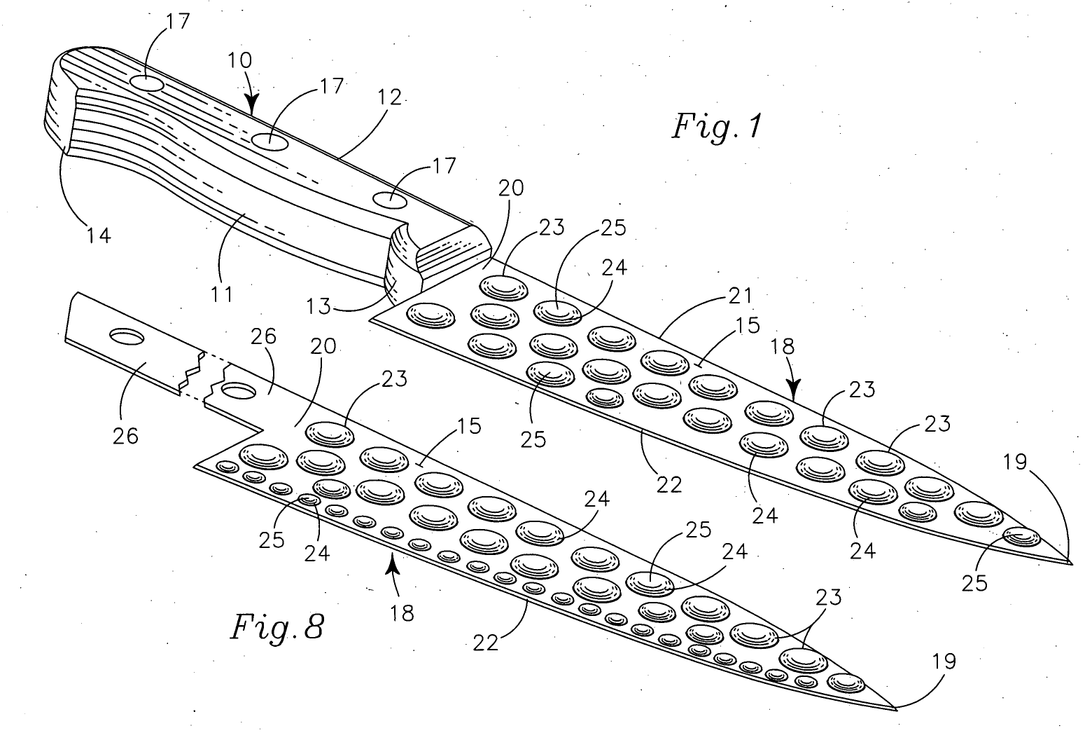

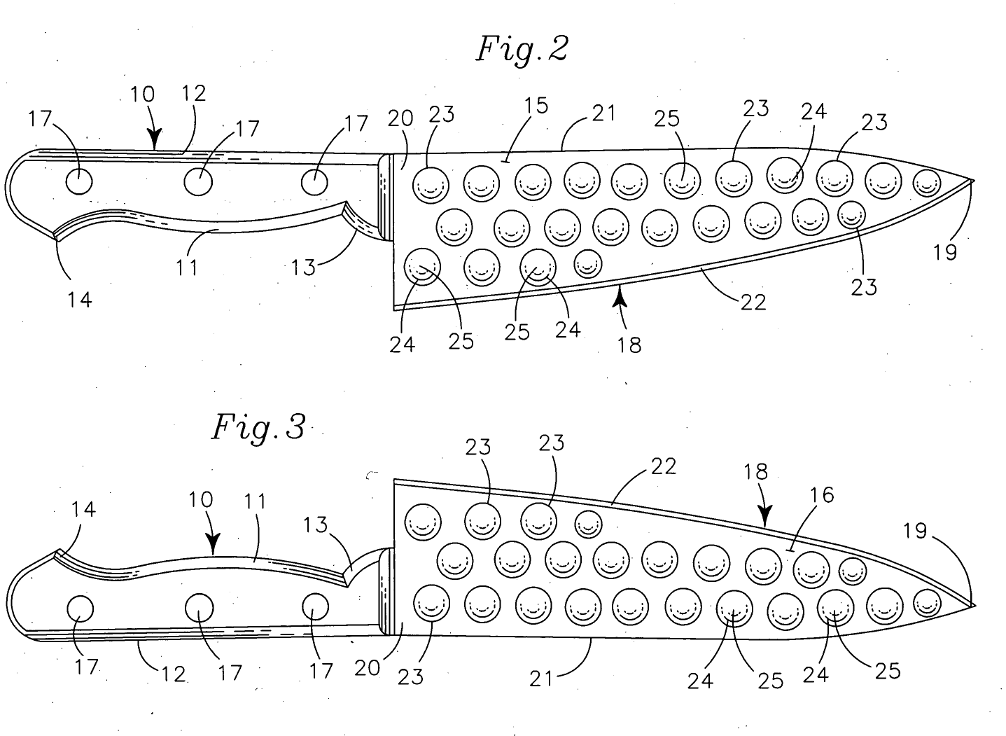

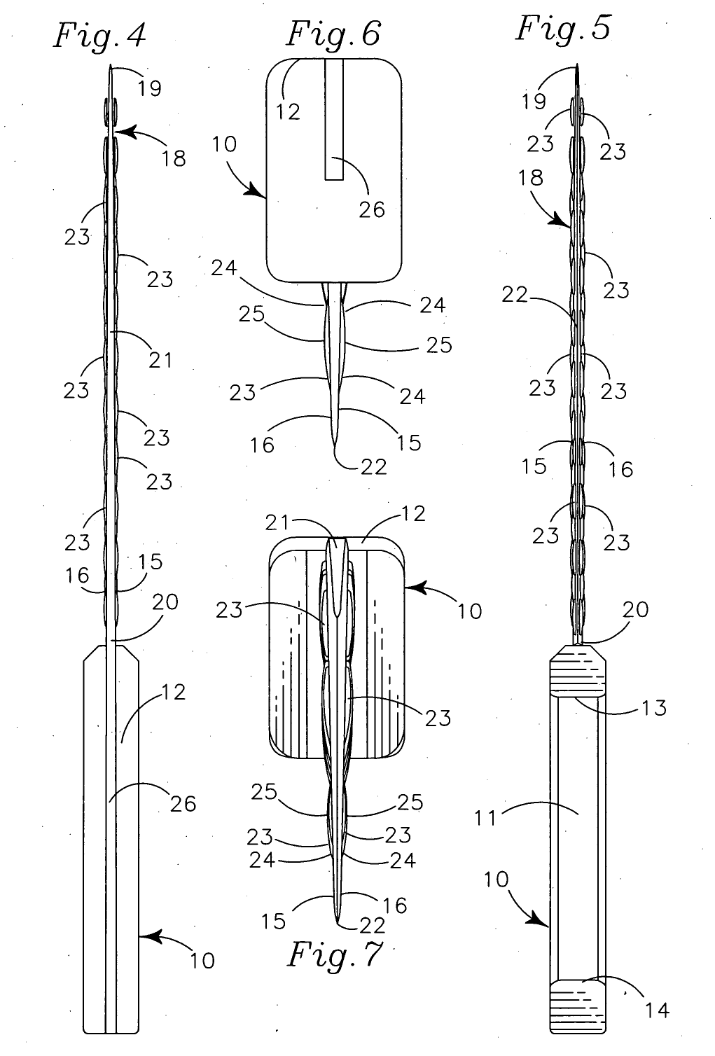

### DESCRIPTION OF PREFERRED EMBODIMENT

My knife blade generally provides a blade 18 having a tip 19, an opposing hilt portion 20 communicating with tang 26, a cutting edge 22, an opposing back edge 21, a first side 15 and an opposing second side 16.

The blade 18 is preferably formed of tempered and hardened high carbon steel that is durable and can maintain a cutting edge 22 over repeated uses and a prolonged period of time. Other materials are likewise contemplated, for example but not necessarily limited to, stainless steel or other metallic alloys having similar physical characteristics, ceramic, metal-ceramic hybrids, thermo-plastics and polycarbonates.

The configuration of the blade 18 may be as shown in Figures, which is commonly described as a “chef's knife”, but other configurations such as broad blades or thin blades, straight blades or arcuate blades, single edge blades or double edge blades and any other of the various shapes of blades may all embody my invention.

The tip 19 is spaced apart from the hilt portion 20 and handle 10. The cutting edge 22 extends along peripheral edge of the blade 18 from the tip 19 to the hilt portion 20 along one edge. The back edge 21 extends from the tip 19 to the hilt portion 20 along edge portion opposite the cutting edge 22.

The cutting edge 22 may be of any type that cuts and slices rigid and semi-rigid food-stuffs or other materials desired to be cut and sliced. The blade of preference is one of the type illustrated with a smooth cutting edge 22. However crenate type and serrated type blades may also embody my invention. The shape of the blade 18 and especially the details of its external configuration are not essential to my invention and may vary.

The handle 10 is elongate with a generally straight back edge portion 12, and a somewhat curvilinear finger edge portion 11 having a leading finger abutment 13 proximate the hilt portion 20 and a spaced apart butt end 14 opposite the blade 18. Fasteners 17, such as rivets and the like, interconnect the handle 10 to the tang 26. Handle 10 may also be forged with the tang 26 during manufacturing to create an integral handle 10 (not shown). The handle 10 shown in the Figures is illustrative of one configuration of handle 10 and is not limiting.

Since my knife blade 18 is normally used in an environment associated with food, the material from which the handle 10 is formed should have appropriate physical and chemical characteristics for use in this environment, such as surfaces that are smooth and that may be easily cleaned, kept reasonably sterile and do not contaminate food stuffs or allow excessive wear when used in normal operative fashion.

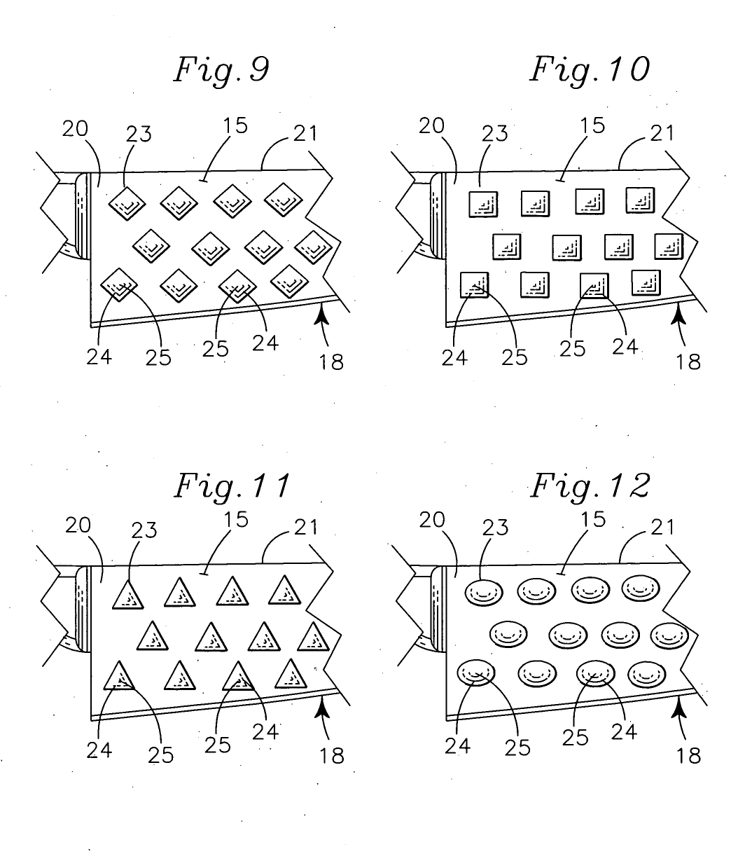

Plural spacedly arrayed protrusions 23 are defined on the first side 15 and the opposing second side 16 of the blade 18. In the preferred embodiment the protrusions 23 are circular and convex in configuration because the circular shape provides an inclined portion 24 communicating from the blade side 15, 16 to a medial crest 25 regardless of the angle or motion of the blade 18. Other configurations of protrusions 23 are likewise contemplated such as diamonds (FIG. 9), squares (FIG. 10), triangles (FIG. 11) and ellipses (FIG. 12).

The dimensions, both diameter and thickness, of the protrusions 23 are dependent upon the specific configuration of the blade 18. For example, in the illustrated embodiment which is known as a chef's knife, the protrusions 23 are approximately 10 millimeters in diameter and have a thickness dimension that does not exceed one-half the thickness of the blade 18 directly under the protrusion 23 so that the inclined portion 24 is gradual with a “run” that exceeds the “rise”. Other blades 18, such as those of the filleting type, (not shown), are much thinner from cutting edge 22 to back edge 23 and therefore would preferably employ protrusions 23 that are smaller in diameter and less thick. If a protrusion's 23 inclined portion 24 is too steep, for instance when the protrusion 23 has a thickness that is greater than the thickness of the blade 18, the protrusion 23 forms an obstruction on the blade 18 that decreases blade efficiency.

The number and placement of the spacedly arrayed protrusions 23 on the blade sides 15, 16 is also dependent upon the configuration and shape of the knife blade 18. As shown in the Figures, protrusions 23 of different diameters and thicknesses may be on the same blade side 15, 16. In the preferred embodiment, protrusions 23 with smaller dimensions are proximate to the cutting edge 22 while protrusions 23 with larger dimensions are more distal from the cutting edge 22. Protrusions 23 may also be spacedly adjacent the cutting edge 22. (FIG. 8).

Although it is preferred that the protrusions 23 be formed integrally with the blade 18, it is also contemplated that the protrusions 23 may be formed separately from the blade 18 and affixed to the blade 18 as a retro-fit improvement to the blade 18.

When the protrusions 23 are formed separately from the blade 18 and are affixed to the blade 18 as an improvement thereto, it is preferable that the separately formed protrusions (not shown) be affixed to the blade 18 with adhesive (not shown) and be formed of a material that is durable, heat and moisture resistant and not susceptible to harboring bacteria or other food contaminants. Materials having these desirable characteristics include but are not limited to stainless steel, metallic alloys, ceramics, polycarbonates, polyethylene, silicone and the like.

Having described the structure of my knife blade, its operation may be understood.

A knife blade 18 is formed according to the foregoing specification and used for cutting essentially in the same fashion as prior knives. The knife is held in one hand by the handle 10 with the cutting edge 22 adjacent the material to be cut and the back edge 21 spaced apart from the material to be cut. In this orientation, the knife is lowered so that the cutting edge 22 of the blade 18 proximate the tip portion 19 contacts the material to be sliced. The knife is pushed forwardly while some downward pressure is applied. As this motion proceeds, a cut will be initiated in the material and the severed material will pass upwardly along the sides 15, 16 of the blade 18. If necessary, the blade 18 may be moved in a reciprocating motion. Such a reciprocating motion is more common if the cutting edge 22 is crenate or serrated. (Not shown).

As the material passes along the sides 15, 16 of the blade 18 from the cutting edge 22 toward the back edge 21, and as the knife passes through the material, the plural protruding convex reliefs 23 frictionally contact the material within the newly formed cut. The material encounters the inclined portion 24 of each protrusion 23 and is gradually forced upwardly away from the blade side 15, 16 along the inclined portion 24 of the protrusion 23 to the crest 25 at which point the inclined portion 24 drops away from the material allowing air between the material and the blade sides 15, 16. As the blade 18 is drawn through the material, or moved in the reciprocating motion, the blade 18 passes further into the material and the cut advances. When the cut is complete and the blade 18 has passed completely through the material there is air between the newly severed slice and the blade side 15, 16. Because there is no vacuum between the material and the sides 15, 16 of the blade 18 the newly severed slice of material falls away from the blade 18 and the cutting process may be repeated to create another slice. Surface friction is reduced because the material being cut is predominantly only in continuous contact with the crests 25 of the protrusions 23 and the cutting edge 22.

Having thusly described my invention, what I desire to protect by Letters Patent, and

What I claim is:

1. A knife blade comprising:
a cutting edge and a spaced apart opposing edge;
a first side and an opposing second side, each side communicating with the cutting edge and the spaced apart opposing edge; and
plural spacedly arrayed protrusions on the first side and on the second side between the cutting edge and the spaced apart opposing edge.

2. The knife blade of claim 1 wherein:
the plural protrusions are spacedly adjacent the cutting edge.

3. The knife blade of claim 1 wherein:
the protrusions are circular.

4. The knife blade of claim 1 wherein:
the protrusions are convex.

5. The knife blade of claim 1 wherein:
the protrusions are diamond shaped.

6. The knife blade of claim 1 wherein:
the protrusions are triangular.

7. The knife blade of claim 1 wherein:
the protrusions are square.

8. The knife blade of claim 1 wherein:
the protrusions are ellipses.

9. The knife blade of claim 1 wherein:
the protrusions are integral with the blade.

10. The knife blade of claim 1 wherein:
the protrusions are formed separately from the blade and are affixed to the blade.

11. The knife blade of claim 1 wherein:
each protrusion has a crest maximally spaced from the blade side and an inclined portion communicating between the blade side and the crest.

12. The knife blade of claim 1 wherein:
each protrusion has a diameter dimension and a thickness dimension and the diameter dimension is larger than the thickness dimension.

13. The knife blade of claim 12 wherein:
the thickness dimension of each protuberance is not larger than the thickness of the blade directly under the protuberance.
